(19) United States
(12) Patent Application Publication
(10) Pub. No.: US 2026/0253151 A1
(43) Pub. Date: Aug. 27, 2026

(54) SYSTEMS AND METHODS FOR EXAMINING PROPERTY INFORMATION AND TITLE

(71) Applicant: James M Phelan, Lexington, MA (US)

(72) Inventor: James M Phelan, Lexington, MA (US)

(73) Assignee: TimeSave Inc., Hyannis, MA (US)

(21) Appl. No.: 19/384,965

(22) Filed: Nov. 10, 2025

Related U.S. Application Data
(60) Provisional application No. 63/717,977, filed on Nov. 8, 2024.

(51) Int. Cl. G06Q 50/16; G06F 16/93

(52) U.S. Cl. CPC G06Q 50/16; G06F 16/93

(57) ABSTRACT

Methods and systems generally related to retrieving documents and information, extracting relevant data, applying rules to the data, and allowing one or more users to add or modify data and results. More specifically, certain embodiments of the present invention relate to systems and methods for drafting a report, generating transfer documents, automating issue resolution with information related to property. Certain embodiments retrieve data related to real estate and produce valuable insights and information for attorneys, agents, insurers, underwriters, lenders, buyers, sellers, grantors, grantees, trustees, and beneficiaries.

### TECHNICAL FIELD

This application claims priority under 35 USC § 119€ to U.S. Provisional Application No. 63/717,977, filed Nov. 8, 2024, and entitled “Systems and Methods for Examining Property Information and Title,” which is incorporated herein by reference in its entirety for all purposes.

### TECHNICAL FIELD

Methods and systems generally related to retrieving documents and information, extracting relevant data, applying rules to the data, and allowing one or more users to add or modify data and results. More specifically, embodiments of the present invention relate to systems and methods for drafting a report, generating transfer documents, automating issue resolution with information related to property.

### BACKGROUND

Transferring property, drafting and executing documents for property interest including deed, mortgage, liens, and other encumbrances or covenants

Purchasers or grantees have a strong need to ensure they are receiving the intended right or interest in the property by title commensurate with their consideration or the grantor's wishes. Grantors or grantees also have a strong need to complete the transfer quickly as an elongated process can increase costs resulting from agent fees and financing terms.

Consequently, the real estate market and law has evolved to create mechanisms to understand and assess interests or title to a given property. One mechanism is with the recording of these interests in public registries with local municipalities or agencies.

Assessing or examining title to a property is often performed by attorneys, firms, or agencies familiar with real estate transfers and knowledgeable about the standards associated with determining whether there are issues in the “chain of title” or encumbrances that could impact the value or “marketability” of the property.

Examining title can be a laborious task. It requires the examiner or agent to retrieve property data and documents from the public record, often from many sources, screen the records for relevancy, determine whether the documents are valid and the rights therein are effective, and assess whether there are issues that must be resolved. In many jurisdictions, significant portions of these processes are manually performed. Due to the number of steps and documents in this process, the potential for error, and the value of the interest at stake, title insurance has become a prevalent part of the real property transfer process to mitigate the risk to grantors, grantees, and practitioners.

To reduce the burden and potential for error, several entities have attempted to create electronic means for title examiners, abstractors, and agents to more efficiently search property records. However, these means focus broadly on obtaining records, extracting data, and validating the data. They neglect to analyze the data, allow interactive user additions and modifications, and generate useful insights, reports, and recommendations for examiners and abstracts. Furthermore, they neglect to leverage this information to expedite the property transfer process and resolve any title issues.

Accordingly, there remains a need in the art for improved systems and methods for examining title, efficiently resolving issues, and expediting the real property transfer.

### SUMMARY

Methods and systems generally related to retrieving documents and information, extracting relevant data, applying rules to the data, and allowing one or more users to add or modify data and results. More specifically, certain embodiments of the present invention relate to systems and methods for an interactive user interface that facilitates title examination and the identification, retrieval, and analysis of key documents and information. Certain embodiments retrieve data related to real estate and produce and expedite valuable insights and information for attorneys, agents, insurers, underwriters, lenders, buyers, sellers, grantors, grantees, trustees, and beneficiaries.

In one aspect, a system is described. In some embodiments, the system includes a computer-device that allows a user to initiate a series of processes via a network connection. The network connects other devices, comprising servers and databases, to perform document retrieval, data extraction and processing, and analysis, reporting, issue resolution, and document generation.

In another aspect, methods are described. In some embodiments, the method comprises document retrieval, data extraction and processing, user addition and modification, and analysis and report generation.

In another aspect, a non-transitory computer-readable medium having computer executable program code embodied thereon is described. In some embodiments, the computer executable program code is configured to cause a computer system to: initiate based on search criteria; retrieve documents related to search criteria; retrieve documents; perform document processing comprising textualizing and/or digitizing the document data; catalog the original document and extracted data; apply rules to the data; and present certain data and documents in a user interface so one or more users can analysis, add, or modify the data and generate a report or summary of the data and findings.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

The figures are described in-line with the text below.

FIG. 1 illustrates a system and architecture for retrieving, processing, and analyzing data and then presenting data for user review, analysis, and modification according to one or more embodiments;

FIG. 2 is a flowchart illustrating the basic steps in a process for retrieving, processing, and analyzing data and then data for user review, analysis, and modification according to one or more embodiments, which may be implemented in the system of FIG. 1;

FIG. 3 is a flowchart illustrating the process for validating entered search criteria according to one or more embodiments;

FIG. 4 is a flowchart illustrating the process for retrieving, storing, preparing, converting, extracting, and validating data and documents according to one or more embodiments;

FIG. 5 is a flowchart illustrating the process for retrieving rules and applying rules to document data; aggregating the documents, data, and analytical results; preparing an output in a user interface that may comprise an abstract, examination, and report; and generating resolutions and documents according to one or more embodiments;

FIG. 6A-6E depicts various input and output products for criteria searching, document retrieving, data processing, database updating, data analysis, and data reporting according to one or more embodiments;

### DETAILED DESCRIPTION

Methods and systems generally related to retrieving documents and information, extracting relevant data, applying rules to the data, and generating a report and automated functions. More specifically, certain embodiments of the present invention relate to systems and methods for drafting a report, generating transfer documents, automating issue resolution with information related to property. Certain embodiments retrieve data related to real estate and produce valuable insights and information for attorneys, agents, insurers, underwriters, lenders, buyers, sellers, grantors, grantees, trustees, and beneficiaries.

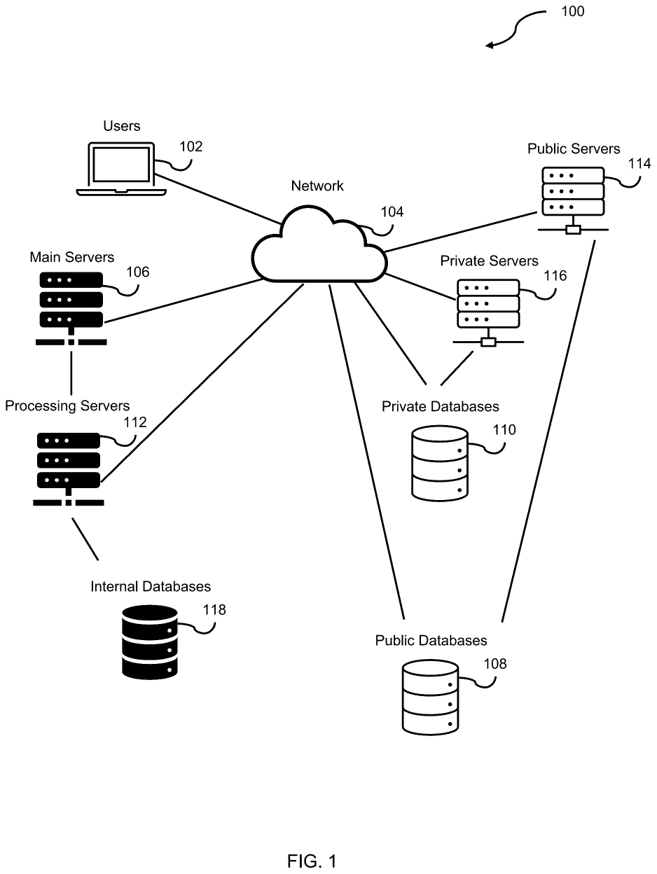

Having described embodiments of the invention generally, attention is directed to FIG. 1, which illustrates an exemplary system 100 according to embodiments of the invention. Those skilled in the art will appreciate that the system 100 is merely exemplary of a number of possible embodiments.

The system includes means of undergoing a process with a connected computing device 102. The computed device is connected to a network 104, which allows the computing device to communicate with main server 106. In some embodiments, the network may comprise the internet, a local area network, a wide area network, a virtual private network, an intranet, and a cloud network, and may include wireless or wired connectivity. The main server manages functions to provide a desirable output to the computing device 102.

The network 104 also facilitates connectivity and thus communication between the main server 106 and other servers and databases. For example, when connected through the internet, the main server is connected to, and can access data from, Public Databases 108 and Private Databases 110. In a non-limiting example, the main server processes a request for a title examination report, through the network 104, by retrieving certain data from Public Databases 108 and Private Databases 110. In this example, Public Databases 108 may include records with town and city tax assessors and Private Databases 110 may include property information stored by companies that serve the real estate industry such as those that host websites for prospective real estate buyers. A person of ordinary skill, with the benefit of this disclosure, will be able to select a particular way for the main server 106 to communicate with said databases.

The main server 106 by way of network 104 may also connect to, and communicate with, other servers to more efficiently execute a process, Processing Servers 112, Public Servers 114, and Private Servers 116. Using the preceding example, the Processing Servers 112 may be dedicated to extracting data from recorded documents, such as deeds, mortgages, tax liens, court judgments, and attachments, populating certain data within a report, such as chain of title, and creating certain documents, such as property transfer instruments. The Processing Servers 112 may include one or more or a combination of these servers working simultaneously, or even asynchronously, in a way that expedites a title examination report.

The Public Servers 114 and Private Servers 116 may include those servers with public or private Application Programming Interfaces (API), respectively, that facilitate efficient communication, data interchange, and data processing between the devices. A person of ordinary skill, with the benefit of this disclosure, will be able to select a suitable devices and method of connectivity. Using the preceding example, Public Servers 114 may include devices operated by towns, cities, and counties to process property information that is available for the general public. Using the preceding example, Private Servers 116 may include devices operated by entities that offer services for machine learning (ML), generative artificial intelligence (AI), and natural language processing (NLP).

Upon the processing and rendering of data via said servers the main servers 106 or the processing servers 112, or combination thereof, will catalog the information computed in the internal databases 118. In some embodiments, the database may be or comprise a table, a relational database, a NoSQL database, a cloud database, a SQL database, a hierarchical database, an object-oriented programming database, a document database, a data warehouse, a PostgreSQL database, or MySQL database, centralized database, network database, or a combination thereof. A person of ordinary skill, with the benefit of this disclosure, will be able to select one or more suitable databases and storage devices.

Once the data have been fully retrieved, processed, and stored, results are prepared using by main servers 106 and rendered to the users 102 via network 106. In the preceding example, the result may be in the form of an interactive title examination report whereby title records are provided, analyzed, and formulaic logic is applied to enable the users 102 to make expedited determinations as to the marketability of title to a given property.

As previously stated, those skilled in the art will appreciate that the system 100 is merely exemplary of a number of possible system embodiments.

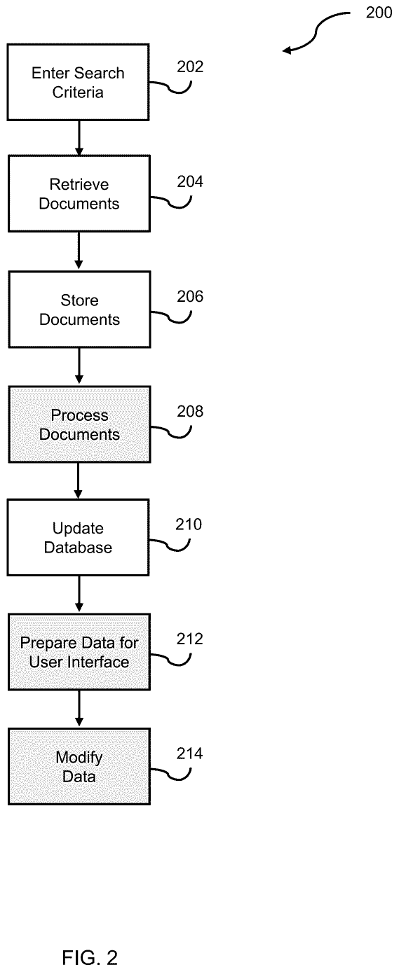

Having described an exemplary system according to embodiments of the invention, attention is directed to FIG. 2, which illustrates an exemplary method 200 according to embodiments of the invention. The method 200 may be implemented in the system of FIG. 1 or other suitable system. Those skilled in the art will appreciate that the method 200 is merely exemplary and other exemplary methods may include more, fewer, or different steps than those illustrated and described herein. Moreover, the various steps in the method 200 may be traversed in orders different that those illustrated and described herein, as is also the case for other methods described herein.

The method 200 begins with entry of search criteria in step 202. In this step, the criteria may comprise information related to a property's address. This may be in the form of a street address and may comprise the minimal amount of information needed to identify the property address. In one non-limiting example, the search criteria may include the street number, street, city, and state. In another non-limiting example, the search criteria may only include the unique ZIP code or 9-digit ZIP code. Because the search criteria is essential to yielding a useful product of the method 200, this step may also include a validation process. This validation process may comprise sub-processes whereby the search criteria is (a) compared to a database of property addresses, (b) matched to a particular property address, (c) modified based on results, or (d) prepopulated based on a partial entry, or a combination thereof. The validation process in step 202 will be described in greater detail hereinafter.

After step 202 yields a search criteria, documents related to the search criteria are retrieved at step 204. Documents may be in any form or media including electronic images, web pages, land plans, land plots, surveyor maps, electronic maps, physical documents, paper documents, digitized documents, text strings, spreadsheets, ASCII data strings, word processor files, programs, or any other form readable by humans or computers. Where documents are not electronic or digitized, it may be necessary to convert said documents to a digital form, such as by scanning or photographing them. Documents may also be retrieved from any accessible source, such as a public, private, or internal database.

Once the documents are retrieved, in some embodiments it's advantageous to store them (either temporarily or permanently) systematically in a database at step 206 with descriptors and unique identifiers. This affords the ability to quickly access them in later steps, as well as more efficiently if related to a different search criteria or the same search criteria entered at a later date. In some instances, this avoids the problem of the document being later relocated or inaccessible from the original source.

After the documents are retrieved and stored as mentioned above, they may be processed at step 208. In some embodiments, these documents will be processed according to type, format, source, and meta data gathered in the retrieval process. In some embodiments, these documents are processed with natural language processing (NLP), machine learning, or generative artificial intelligence (generative AI). Information from the documents, comprising characters, images, and text will be extracted and characterized into data related to the document and search criteria. In some non-limiting instances this includes extracting information from documents such as parties, titles, names, entities, descriptions, dates, signatories, notaries, addresses, birthdates, tax identification numbers, unique identifiers, and definitions which may or may not include legal information or other meta data. In some non-limiting examples, the documents may be legal documents such as deeds, mortgages, tax liens, discharges, attachments, judgments, or settlements. In some non-limiting examples, the data may include land coordinates, property descriptions, tax records, value estimates, contractual consideration, transfer information, probate information, bankruptcy information, contact information, agency information, and jurisdictional information. This data may then be used in further processing steps whereby it may be validated, converted, analyzed, stored, and summarized.

In some embodiments, it's advantageous to update the internal database with at least partial data from step 208 at step 210. A person of ordinary skill, with the benefit of this disclosure, will be able to select a suitable database. In some embodiments, the database may be or comprise a table, a relational database, a NoSQL database, a cloud database, a SQL database, a hierarchical database, an object-oriented programming database, a document database, a data warehouse, a PostgreSQL database, or MySQL database, centralized database, network database, or a combination thereof.

The document retrieval, storage, and processing process as well as the database updating process will be described in greater detail hereinafter.

Once the relevant documents and processed data are readied, the data can be analyzed and prepared at step 212. In some embodiments, this method includes retrieving at least partial information about the jurisdiction and applicable law, regulations, and title standards. In some embodiments, this information is applied to the documents of 204 and 206 and the data of steps 208 and 210 to generate a data analysis. In one non-limiting example, the data analysis may include information about whether a mortgage has an associated discharge or a mortgage was recorded more than 50 years ago. In another non-limiting example, the data analysis may include information about whether a particular property has tax lien or legal judgment recorded in a particular public database or registry of deeds. After the data is analyzed and prepared, it can be presented in a user interface that can be interactive to the user.

After the data is analyzed, prepared, and presented the user can modify, add, or amend the data at step 214. In some embodiments, the data in the user interface will resemble a title report, title examination report, or title abstract. In some embodiments, the user interface will include various views of the data that can organize the data chronologically or by other identifiable information such as by party, grantor, grantee, address, or type of document. The user interface at least partially comprises one or more of the following: the property address, owners, entities, chain of title, grantors, grantees, successors, beneficiaries, trustees, assignees, officers, interest holders, related documents, related data, land plan, property map, map of location, subdivision, boundaries, bodies of water, natural resources, encroachments, improvements, structures, buildings, neighboring properties, legal description, encumbrances, covenants, liens, mortgages, deeds, judgments, rights, conveyances, title information, insurance providers, report generators, report date, report requestors, images, pictures, videos, hyperlinks and other formatting or useful features known to be used in printed, electronic, bankruptcy proceedings, death certificates, trusts, trust abstracts, land surveys, subdivisions, master deeds, homeowner's association documents, betterments, takings, easements, or interactive or static reports.

The user interface and data modification process will be described in greater detail hereinafter.

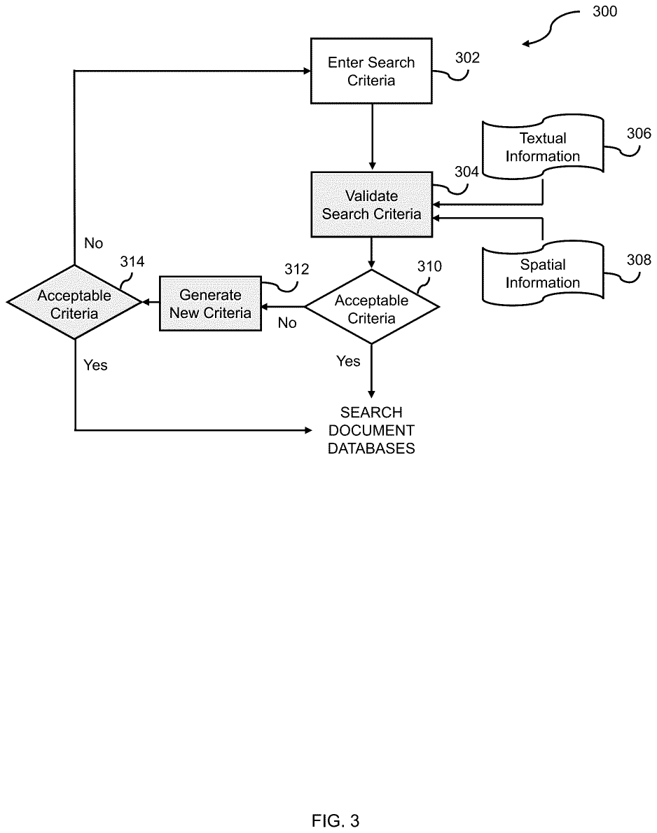

Attention is directed to FIG. 3, which illustrates an exemplary search criteria method 300 according to embodiments of the invention.

The method 300 may be comprised by the step 202 of the method 200 of FIG. 2, although that is not necessarily the case. The method 300 begins at block 302, at which point search criteria is entered. In some embodiments the search criteria is entered through an integration to another network or software-based system or directly by a user. In some embodiments, the search criteria is a property address, which may include at least partial information described in step 202. After entry, the criteria is validated at step 304. Here, an operating process uses information from various data sources and develop a result of whether the criteria exists elsewhere in a similar context. Accordingly, processes in step 304 use information from sources that could be related to textual information 306 or spatial information 308. In some embodiments, the textual information may include jurisdictional information related to the legal jurisdiction. In some embodiments, it may include written information about that property from one or more sources. In some embodiments, the spatial information may include geographical information about the property, such as land coordinates, land plans, maps, legal descriptions, and GIS data from one or more sources. In some embodiments this information is available from public, private, or internal resources.

Once information has been obtained, step 304 applies a comparative process. In some embodiments this process uses public, private, or internal analytical methods. In one instance, step 304 may use APIs to interface with public or private platforms such as those leveraging generative AI, NLP, or their own proprietary tools and databases, such as Google Maps Platform.

The comparative process then produces a result where at step 310 a decision is rendered whether the criteria is acceptable to continue in the process. If it is not, similar data and processes from step 304 are utilized to generate alternative criteria at step 312. Then, at step 314, a human verification process prompts the user to select the computer-generated modified criteria or re-enter new search criteria themselves at step 302. In some embodiments, step 314 is interactive with the user and may use generative AI or NLP or a combination thereof.

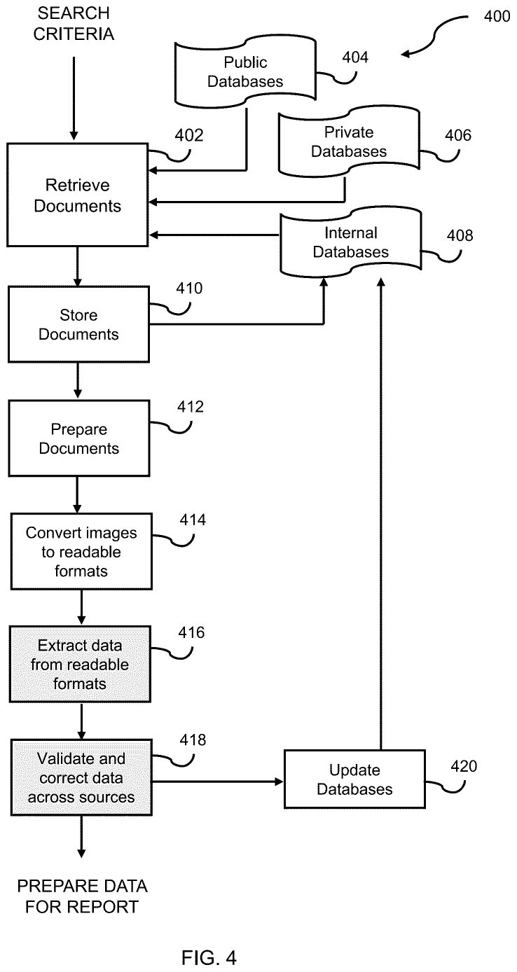

Attention is directed to FIG. 4, which illustrates an exemplary document retrieval, storage, processing, and database updating method 400 according to embodiments of the invention.

The method 400 may be comprised by steps 204, 206, 208, and 210 of the method 200 of FIG. 2, although that is not necessarily the case. The method 400 begins at block 402, at which point documents are retrieved based on search criteria.

Documents may be in any form or media as described above. Documents are retrieved from various sources, which may include Public Databases 404, Private Databases 406, or Internal Databases 408. Non-limiting examples of document retrieval include searching, downloading, extracting, scrapping, electronic communication requests (e.g. email), scanning, copying (e.g. digital or hard), and downloading. In some embodiments, these databases include publicly recorded instruments such as deeds, loans documents, betterments, and trust certificates. Once retrieved, these documents may be stored temporarily or permanently on internal systems and databases at step 408 to expedite current and future processing. Documents are then prepared at step 412 for processing. In some embodiments, this includes removal of certain data or cataloging of certain data, such as meta data and other document data that may be available on host platforms to describe aspects of the document, such as by way of an abstract of said document.

Once prepared, aspects of the documents may be converted to computer-readable formats at step 414. In some embodiments, this includes OCR for conversion to text. In some embodiments, this includes pattern recognition or the like. Once the documents are converted, data extraction occurs at Step 416, which is a key process in this method. In some embodiments, data extraction includes applying generative AI, NLP, deep neural networks, convolutional neural networks (CNN), and pattern recognition. In some embodiments, the method uses a rule engine and model training to update the rule engine. In some embodiments, step 414 and 416 are integrated in one step.

After data extraction, the data is validated or modified at step 418. In some embodiments, several documents with similar information are extracted in prior steps. This available information can be applied across data sources to correct any errors in the processing or in the original documents. Thus, step 418 is valuable to improving the accuracy of data and reliability of method 200.

Finally, once validated and corrected, the data can be utilized for report preparation and the documents and data can be cataloged within internal databases at step 420. As noted above, in some embodiments, it's advantageous to update the internal database with at least partial data from step 418. A person of ordinary skill, with the benefit of this disclosure, will be able to select a suitable databases at 408. In some embodiments, the database may be or comprise a table, a relational database, a NoSQL database, a cloud database, a SQL database, a hierarchical database, an object-oriented programming database, a document database, a data warehouse, a PostgreSQL database, or MySQL database, centralized database, network database, or a combination thereof.

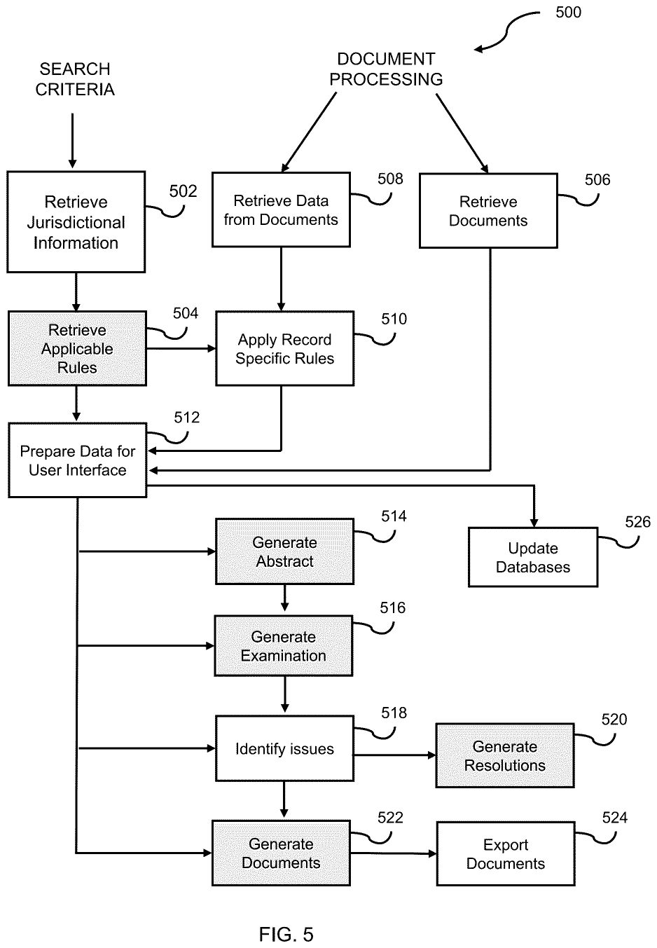

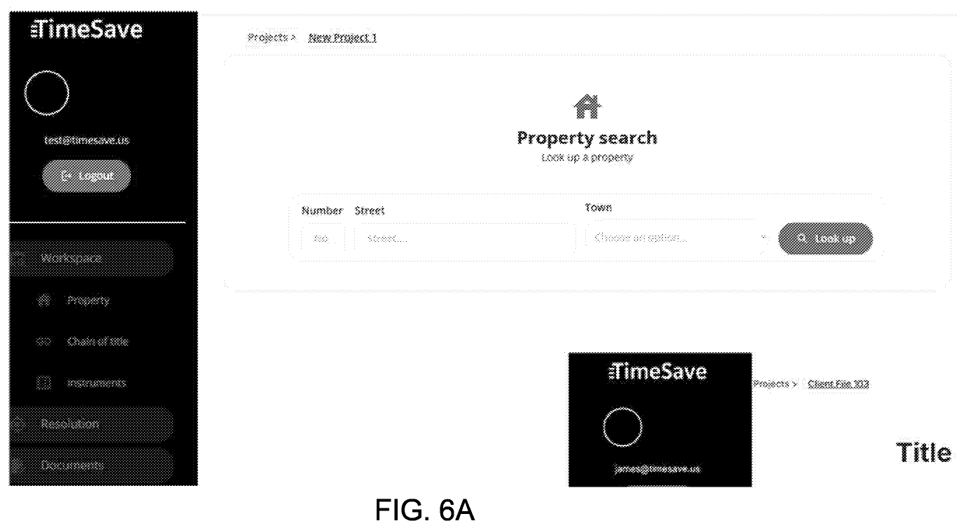

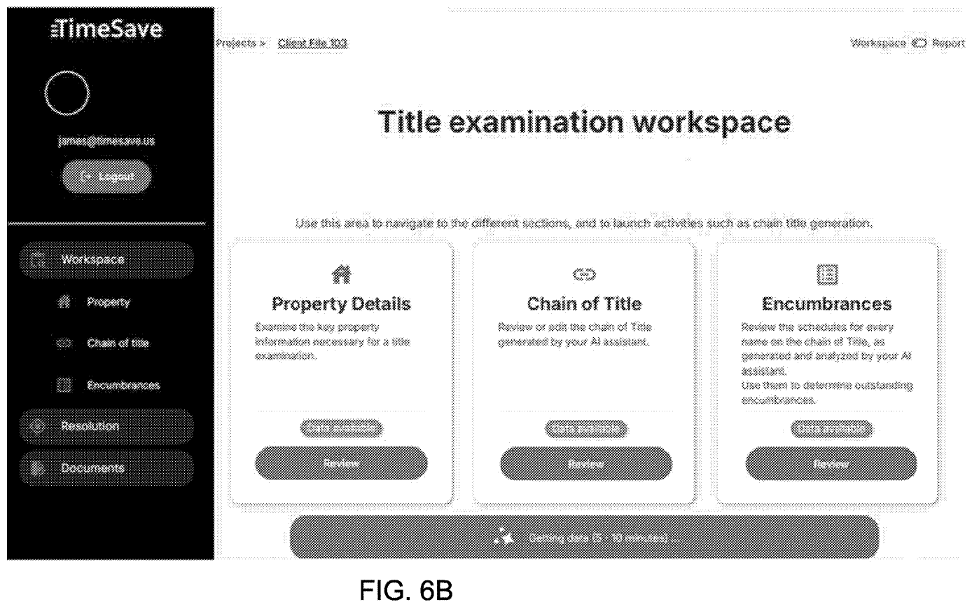

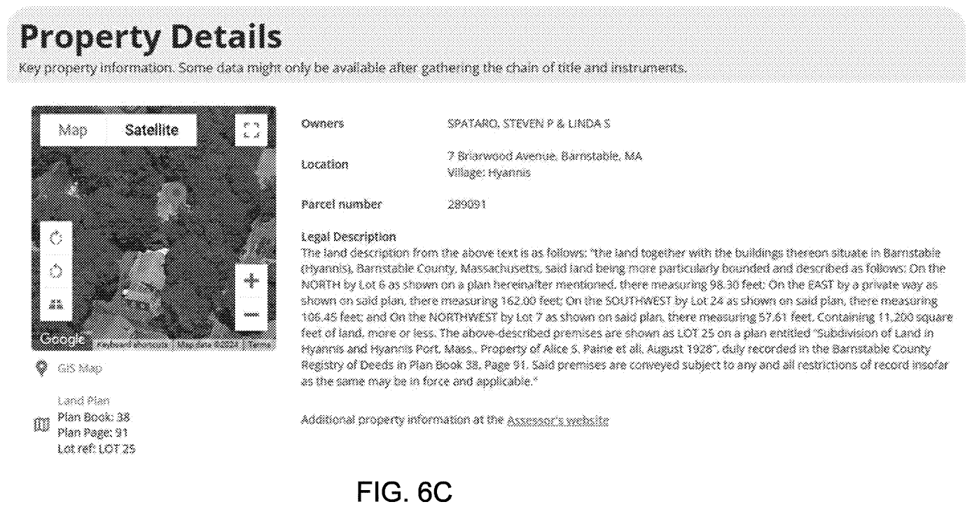

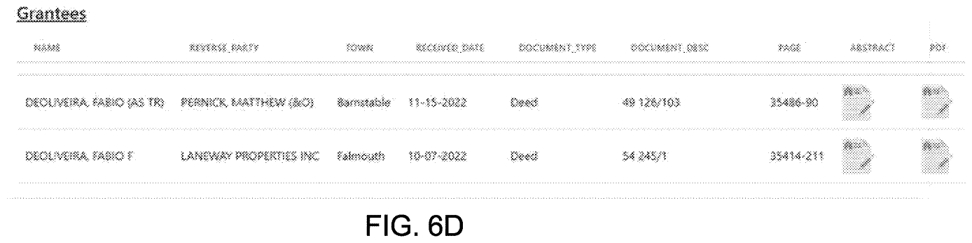

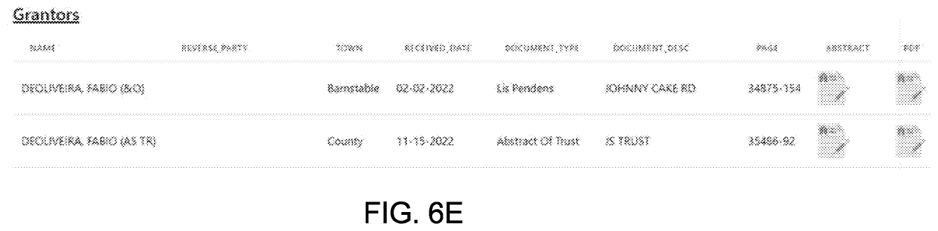

Attention is directed to FIG. 5, which illustrates an exemplary data analysis and reporting method 500 according to embodiments of the invention.

The method 500 may be comprised by steps 212 and 214 of the method 200 of FIG. 2, although that is not necessarily the case. The method 500 begins at step 502 where textual and spatial information related to the search criteria is obtained. In some embodiments, this includes jurisdictional information related to real property. Next, using step 502 information, rules and standards are retrieved at step 504. In some embodiments, this includes town rules, city ordinances, state laws, federal regulations, and title standards that apply with the transfer of title or the holding of an interest in real property. In some embodiments, this includes rules or standards to determine if a potential real estate encumbrance has been discharged, released, waived, terminated, or expired through the statute of limitations, title standards, or other law, regulation, or customary practice.

In parallel to steps 502 and 504, steps 506 and 508 yield documents and data from early steps in the method. The documents retrieved from step 506 are included in report preparation in a native or similar to native form, while the data from step 508 is utilized with the rules from step 504 to produce new data specific to the search criteria, records, and unique to the report. In some embodiments, this includes the use of generative AI or NLP or derivation of rules from resources with legal information or retrieval of rules from internal databases or at least a partial combination thereof. In some embodiments, this includes applying rules to mortgage documents to determine if the mortgage is outstanding. In some embodiments, this includes applying rules to a deed to determine if the document was executed correctly. In some embodiments, this includes whether a recorded lien is no longer effective within a statutory period or statute of limitations. In many instances, the method described can substantially expedite the analysis of important documents that can have significant legal implications. Once applied in step 510, the results are ready for step 512, where results from 504 and 506 are also aggregated to prepare a readable output and format for the user interface.

Blocks 514, 516, 518, 520, 522, and 524 generally include generation of an output that informs a user or performs an action for a user. These steps may happen in isolation, especially if that is desirable for the user, or collectively to produce more comprehensive results for the user. In some embodiments, block 514 generates a brief summary of the documents and data, also known as an abstract or report. In some embodiments, a more thorough analysis of the documents and data is desired, so an examination including rule application at block 516, using information gathered at block 504 and 510, would be an output. In some embodiments, the examination would include the application of rules or artificial intelligence on a particular document to make a determination on the extracted data. In some embodiments, the determination would be whether or not the document, right, or encumbrance is related to the locus (property), the owners or grantors or grantees, or whether the right or encumbrance is still effective. In some embodiments of this step, a user can modify or add records, documents, and data to supplement, expand, or reduce the data produced by preceding steps. Further, in some embodiments, specific issues may be identified from the analysis at block 518. A logical next step would be to resolve those issues, which is performed at block 520. Some non-limiting examples of issue resolution action include additional data gathering, communication to certain parties in a position to resolve the issue, or payment to a particular party. Furthermore, with the data, documents, analysis in-hand, method 500 has the necessary information to generate useful preliminary documents at step 524. In some embodiments, these documents may include a draft conveyance document, trust certificate, discharge, deed, statement, plan, procedure, trust, or other document with legal relevance or a combination thereof. Once prepared, these documents can be exported or downloaded at block 524. In some embodiments, method 500 leverages generative AI or NLP or similar systems to complete the process, particularly blocks 504, 514, 516, 520, and 522. At this stage, the process is complete and the user has valuable information and outputs in an interactive user interface. In some embodiments, the user interface includes an option to generate an abstract or report in a printable format or file that could be exported.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Additionally, a number of well-known processes and elements have not been described in order to avoid unnecessarily obscuring the described invention. Those skilled in the art will recognize, or be able to ascertain using no more than routine experimentation, many equivalents to the specific embodiments of the invention described herein. For examples those skilled in the art will arrange computational devices in a network to enable proper communication. Further, those of ordinary skill in the art will realize the described invention is not limited to analyzing or assessing property and examining real estate title. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,”“holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A system comprising:
a search module configured to apply, or modify and apply, initial search criteria;
a retrieval module to use search criteria and retrieve information that comprises images, data, documents, and images, collectively data;
a user interface module that allows the user to view, add, or manipulate data; and
a rule module to apply rules to the data.

2. The system of claim 1, wherein the retrieval module accesses, private, public, or internal database, or any combination thereof.

3. The system of claim 1, wherein the system retrieves documents related to real estate.

4. The system of claim 1, wherein the system generates a report.

5. The system of any one of claims 1-4, wherein the system generates one or more documents.

6. The system of any one of claims 1-5, wherein the system generates one or more resolutions to an identified issue.

7. The system of any one of claims 1-6, wherein the system is interactive, whereby the user is able to initiate further actions or access further information or a combination thereof.

8. The system of any one of claims 1-7, wherein the system is interactive, whereby the user is able to initiate further actions to add or modify documents, data, or the database or the metadata thereof.

9. The system of claims 8, wherein the addition or modification is accessible to one or more users.

10. A non-transitory computer-readable medium having computer executable program code embodied thereon, the computer executable program code configured to cause a computer system to:
initiate on initial search criteria;
retrieve documents related to initial and/or modified search criteria from one or more databases;
store retrieved documents;
perform document processing comprising textualizing and/or digitizing the document data;
catalog the original document and extracted data;
allow one or more users to add or modify the documents, data, or results; and
apply rules to the extracted data to generate new situational or time-based data.

11. The non-transitory computer-readable medium of claim 10, wherein the computer executable program code is configured to further generate a report comprising the original documents, extracted data, and new data generated from the application of rules

12. The non-transitory computer-readable medium of any one of claims 10-11, wherein the computer executable program code is configured to further cause the computer system to utilize information from public, private, or internal databases, or any combination thereof.

13. The non-transitory computer-readable medium of any one of claims 10-12, wherein the computer executable program code for applying the initial search criteria applies modifications to the search criteria.

14. The non-transitory computer-readable medium of any one of claims 10-13, wherein the computer executable program code for applying the initial search criteria offers modifications to the search criteria, which a user can approve or decline for further use.

15. A computer-implemented method, comprising:
searching for documents, document images, and data relevant to property, interests, rights, or title, or any combination thereof;
retrieving a plurality of said documents, document images, and data;
extracting data from documents and document images;
processing, validating, and amending the data across various documents and sources;
allowing one or more users to add or modify the documents, data, or results; and
applying rules to the documents, images, and data.

16. The computer-implemented method of claim 15 wherein one or more elements of the processed documents, images, and data in a report.

17. The computer-implemented method of any one of claims 15-16, wherein the information, data, images, or documents is relevant to real estate or a conveyance.
